(19) United States
(12) Patent Application Publication
(10) Pub. No.: US 2003/0164620 A1
(43) Pub. Date: Sep. 4, 2003

(54) Handling device, especially vaccum handling device

(76) Inventors: Kurt Schmalz, Dornstetten (DE); Thomas Eisele, Fluorn-Winzeln (DE); Dieter Geissler, Enzklosterle (DE)

Correspondence Address: William M Hanlon Jr, Young & Basile, Suite 634, 3001 West Big Beaver Road, Troy, MI, 48084, US

(21) Appl. No.: 10/220,006

(22) PCT Filed: Jan. 16, 2001
(86) PCT No.: PCT/EP01/00405

(30) Foreign Application Priority Data
Feb. 26, 2000 (DE) 100 09 108.3

(51) Int. Cl. B25J 15/06

(52) U.S. Cl. 294/64.1

(57) ABSTRACT

The invention relates to a vacuum handling device with a suction box (12), a vacuum blower (22), a handling device (16) and a suction unit (20) obturating the suction box and consisting of a suction plate (26) and a suction pad (30). The inventive handling device is further characterized in that the suction unit is provided with suction openings (36) that have a certain flow resistance.

### BACKGROUND

The invention relates to a handling device, specifically a vacuum handling device having a suction box forming a vacuum reservoir, at least one vacuum blower, a handling device and a suction unit covering the suction box toward one or more objects to be picked up by vacuum, wherein the vacuum unit has a suction plate with flow changing means and the suction plate is covered by a flexible suction pad toward the workpiece or workpieces and the suction pad is provided with suction openings which match the flow changing means in the suction plate, wherein the suction pad consists of a particularly flexible, dense material, for example a closed-cell foam, and the flow changing means of the suction plate and/or the suction openings of the suction pad demonstrate a resistance to flow.

Handling devices are known from DE 37 41 091 A1, DD 209 424, EP 0 267 874 A1, DE 30 47 717 A1, GB 2 062 577 A, DE 33 42 424 A1, U.S. Pat. No. 4,787,812 and FR 2 291 172 A, with which workpieces can be lifted by means of vacuum. These devices have a suction box covered by means of a suction unit on the side facing the workpiece. This suction unit consists of a perforated plate and a suction pad, which have matching suction openings. When the suction unit is covered by the workpiece, the workpiece is held by vacuum and it can be transported. However, problems arise when the suction unit is not completely covered by the workpiece or workpieces, with the consequence that so much air is sucked in through these non-covered areas that insufficiently high vacuum can be created to pick up the workpieces by vacuum.

### SUMMARY

The invention is therefore directed to further develop a handling device, specifically a vacuum handling device of the type described above such that workpieces can be picked up securely by vacuum even when the workpieces are uneven and the suction unit is only partially covered.

The invention provides a handling device, specifically a vacuum handling device of the type described above and interposes at least one intermediate pad between the suction pad and the suction plate, the pad similarly formed of a flexible material and provided with through openings which match the suction openings.

Due to the fact that the suction pad is formed of a closed-cell foam and its suction openings and/or the openings in the suction plate represent a resistance to flow, a vacuum can still be generated in the suction box, even if the suction unit is not completely covered by one or more workpieces. Air is still drawn in through the uncovered openings, but the volume flowing in through these openings is less than the volume of air drawn off by the vacuum blower. The openings in the suction plate have a specified flow resistance, for example, because of their small cross sectional opening. The suction openings in the suction pad can, for example, be similarly adjusted by means of the cross section with respect to their resistance to flow, which can also be achieved by means of the length of the suction openings. The suction unit is stiffened by the sandwich construction formed by the intermediate pad and the suction pad so that there is no further risk of lateral collapse. The suction unit remains so flexible that it can conform to uneven objects so that the objects can easily be picked up by vacuum.

In a further improvement, the suction unit has an additional flexible rim on its circumference. The function of the rim is to allow even workpieces projecting beyond the suction box, that is, the suction unit, to be picked up by vacuum and held firmly. This is the case even when the workpieces bow when they are lifted, since the flexible rim gives and follows the workpiece. The workpiece is thereby prevented from peeling away from the suction unit.

In several aspects the rim is a foam material or a rubber lip which projects beyond the free plane of the suction unit. When the suction unit is positioned on the surface of the workpiece, either the foam is compressed or the rubber lip is bent back so that the flexible rim lies snugly under pre-load on the surface of the workpiece. If the workpiece subsequently attempts to escape, for example as the result of bowing, the rim can follow the workpiece without difficulty and continues to form a seal against the workpiece.

Under the invention, the rim is secured by means of clamping or bonding to the suction unit or the suction box. Securing by means of a clamp has the considerable advantage that in the event of a repair the rim can be easily detached and replaced with a new one. Bonding has the advantage that no special clamping devices are required and bonding can be carried out quickly and simply. Using suitable tools, a bonded rim can similarly be removed without leaving a residue.

In one version of the embodiment, the suction unit is bonded or clamped to the suction box. Here too, clamping offers the advantage that the suction unit can be removed without destroying it and exchanged as necessary for a suction unit adapted to other workpieces. If it is not necessary to change between different suction units, the suction units are preferably bonded to the underside of the suction box.

In a preferred aspect, the suction plate has a dished configuration and has a circumferential rim by means of which the suction plate is clamped to the suction box. The dished configuration has the considerable advantage that lateral clamping devices do not interfere, since the suction plate projects beyond these clamping devices toward the workpiece because of its dished shape. Furthermore, the volume of the suction box and consequently the vacuum reservoir is increased as a result of the dished shape. Finally, this pan-like shape has the further advantage that rims can be formed on its lateral surfaces, that is, on its circumference, to seal the suction space laterally.

One aspect provides for configuring the suction plate as a film. One advantage of this film is that it is relatively flexible. Another advantage is that it can be furnished relatively easily with the desired openings, specifically holes, so that the desired flow resistance can be produced relatively simply. If the suction plate consists of a film, the suction unit can furthermore lie flush against uneven objects and lift them. Moreover, the effect of bowing from panel-shaped objects is not as serious as with rigid suction units, since it is possible to adapt to the bowed shape of the workpiece in the case of the flexible suction unit in accordance with this embodiment. The risk of the workpiece peeling off is considerably reduced.

In an improved version the suction plate is supported on its back side by means of an air-permeable flexible pad. This pad serves on the one hand to stiffen the suction unit, if this should be necessary, and on the other hand, flow resistance can be set to desired values using the pad.

Another version provides for the suction pad to be of multi-piece configuration and for one piece to be formed from a non air-permeable flexible pad with air passages. In this way, flow resistance can be set precisely through the dimensions of these air passages, where, due to the flexible construction of the suction pad, optimal contact with the workpiece is possible. To prevent pulling in outside air, the circumferential surface of the pad in one aspect is sealed in an air-tight manner.

Another version provides for the suction pad to have suction openings whose cross sections expand in the direction of the workpiece or workpieces. In this way relatively large suction chambers are created at the surface of the workpiece, with the suction chambers narrowing into relatively narrow suction passages which possess the desired cross section, whereby the requisite flow resistance is set. The suction cross sections open out advantageously in a tulip shape.

In one version, provision is made for the suction pad to have a circumferential rim projecting beyond the suction plate, the rim easily preventing sheet metal panels which have been lifted by vacuum from peeling off.

Advantageously, the openings of the suction plate, or the suction openings of the suction pad, respectively, have a regular grid pattern, for example, a honeycomb pattern, or they match the arrangement of the workpieces.

In an improved version, provision is made for a sandwich plate to be positioned between the intermediate pad and the suction pad. Stiffness against lateral collapse is further increased by means of this sandwich plate, ensuring that air can be drawn off through the flow passages under all conditions (even through those lying in the peripheral area).

In one aspect, the sandwich plate extends only over one part of the cross sectional area of the intermediate pad, specifically the sandwich plate is configured in strips and located in the peripheral area of the intermediate pad, or of apertures. If a detection system using cameras or similar, for example, is to be integrated into the gripper, the suction pad is furnished with apertures through which the detection system can identify the objects.

An alternative aspect of the invention provides for the sandwich plate to have a strip-like configuration and for the strips to be spaced apart.

One version of the invention provides for the sandwich plate to extend over the entire cross sectional area of the intermediate pad.

In one improvement of the invention, several intermediate pads and sandwich plates are provided, and the suction unit is a multi-layer sandwich construction.

One improvement provides for the flow changing means to be a plurality of openings resistant to flow and/or flow valves. The flow valves can be actuated individually or in groups. Particularly when the invention is used on a robotic system, the suction areas can be precisely specified or changed as desired in this way. Moreover, flow resistance can be adjusted and altered between zero and fully blocked.

### BRIEF DESCRIPTION OF THE DRAWING

Additional advantages, features and details of the invention can be found in the subclaims and the subsequent description, in which particularly preferred aspects are described in detail with reference to the drawings. The features shown in the drawings and mentioned in the description and the claims can be fundamental to the invention individually or in any combination. In the drawings:

FIG. 1 shows a side view (partly in section) of one aspect of the vacuum handling device in accordance with the invention,

FIG. 2 show a view II from FIG. 1;

FIG. 3 shows a plan view of the handling device from FIG. 1;

FIG. 4 shows a plan view of one aspect of a suction plate;

FIG. 5 shows an enlarged partial reproduction of one corner V from FIG. 4;

FIG. 6 shows a plan view of one aspect of a suction pad;

FIG. 7 shows an enlarged partial reproduction of one corner VII from FIG. 6;

FIG. 8 shows a cross section through a first aspect through a suction box with attached suction unit;

FIGS. 9-12 show four additional aspects of a suction box with attached suction unit;

FIG. 13 shows a plan view of one aspect of a suction pad with sandwich plate;

FIG. 14 a section XIV-XIV from FIG. 13;

FIG. 15 a plan view of one aspect of a suction pad with sandwich plate; and

FIG. 16 shows a section XVI-XVI from FIG. 15.

### DETAILED DESCRIPTION

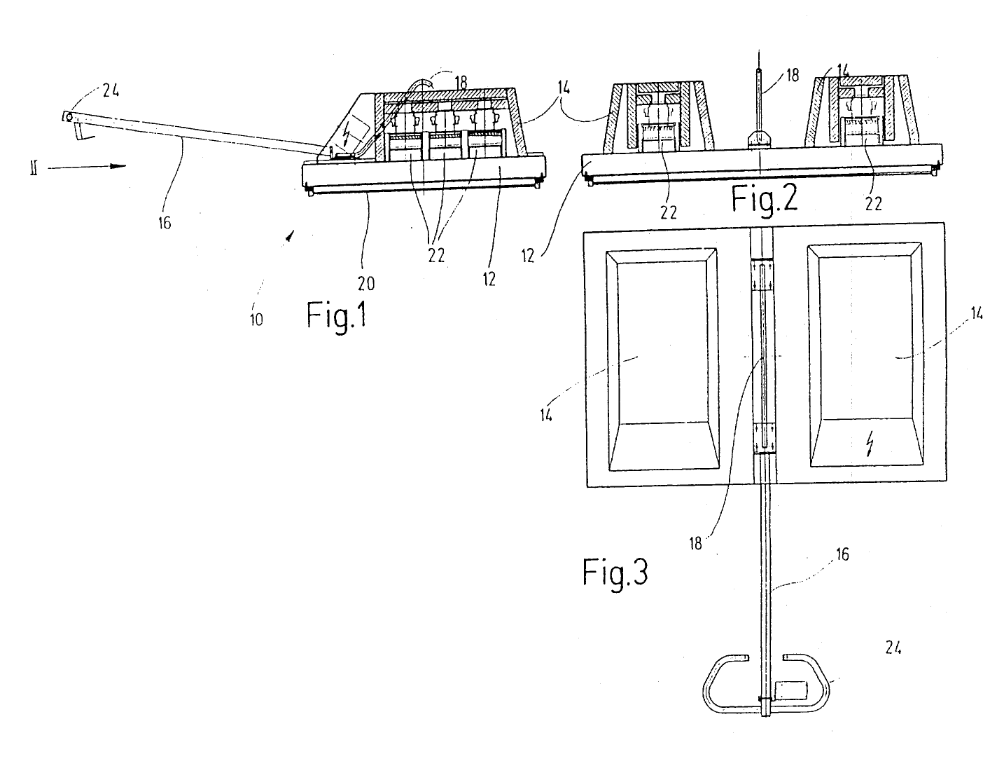

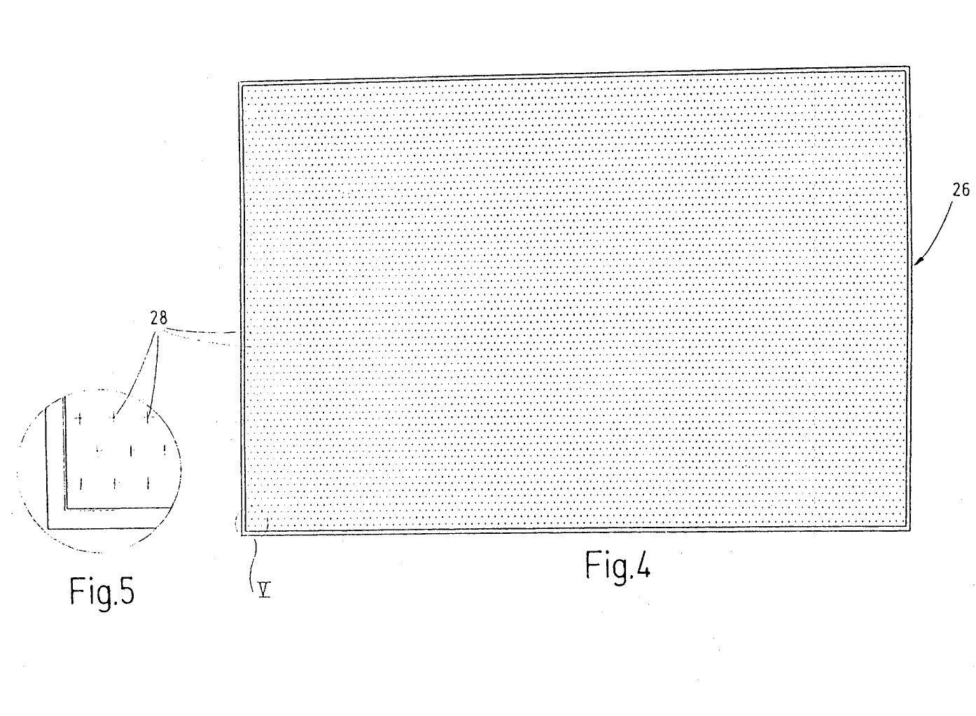

FIG. 1 shows an aspect of the vacuum handling device 10 in accordance with the invention, which basically has a suction box 12, a hood 14, a handling device 16, a suspending device 18 and a suction unit 20. Several vacuum blowers 22 are provided under the hood 14, with which a vacuum is created in the suction box 12. As can be seen from FIG. 2, two hoods 14 are provided on the suction box 12, so that the vacuum is created by a total of six vacuum blowers 22. Actuation of the blowers 22 is controlled by means of the handling device 16, on whose handle 24 appropriate control elements are provided. The vacuum handling device 10 is also placed on top of the workpieces to be handled (not shown) with the handling device 16, that is, the device 10 is positioned. Pickup and release of the workpieces is carried out through the aforementioned control elements.

In order to lift the vacuum handling device 10, suspending device 18 is provided which, by way of example, can be attached to a suitable lifting device such as a chain hoist. The device can however also be flanged to a robotic arm.

The suction unit 20 basically has a suction plate 26 which is furnished with a plurality of openings 28 (FIG. 4 and 5). These openings 28 have a small cross section and thus present a relatively high resistance to flow. The openings 28 are advantageously arranged in a regular pattern and are equally spaced from each other, which can be clearly seen from FIG. 5, namely they are arranged in a honeycomb pattern.

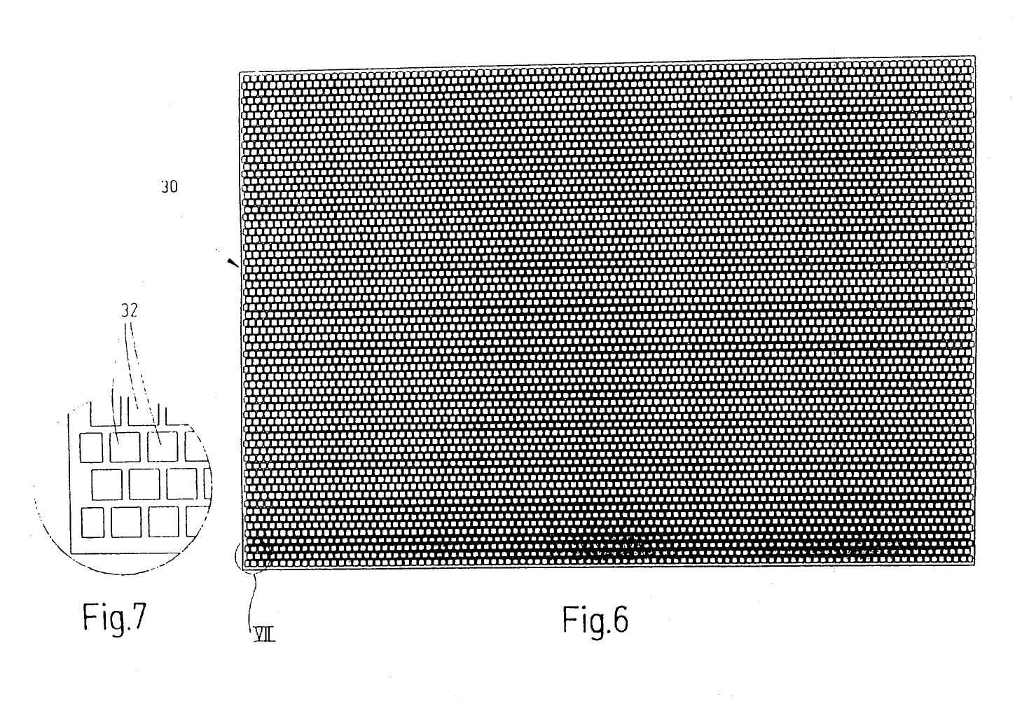

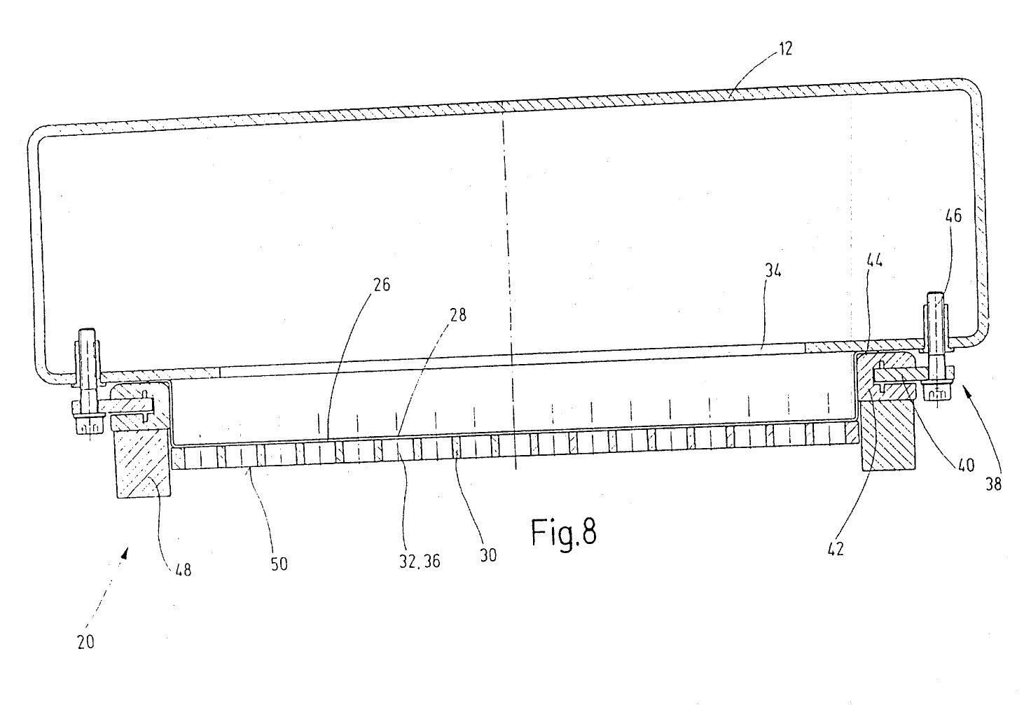

FIGS. 6 and 7 show a suction pad 30 which lies flush on the upper side of a workpiece when lifting a workpiece by vacuum. This suction pad 30 has a plurality of suction chambers 32 which are disposed in the same dimensional grid as the openings 28. However, the suction chambers 32 have a considerably larger cross section than the openings 28, so that the latter create almost no resistance to flow. The suction pad 28 consists of a closed-cell flexible material. Advantageously a closed-cell foam material is used for this, which preferably has an abrasion-resistant coating.

FIG. 8 shows a first aspect of the suction unit 20 which is attached to the underside of the suction box 12. The suction unit 20 covers one suction opening 34 of the suction box 12 and closes off this suction opening 34, so that a vacuum can be created inside the suction box 12.

The suction unit 20 has the suction plate 26, which in this aspect has a dished configuration. The suction pad 30 is attached to the underside of this suction plate 26, where the openings 28 of the suction plate 26 align with the suction openings 36, or suction chambers 32, of the suction pad 30. The suction pad 32 is furnished with an adhesive layer on the side facing the suction plate 26 and is bonded to the suction plate 26.

A clamping device 38, which has a clamping strip 40 around which a formed rubber 42 is placed, is employed to attach the suction unit 20. The projecting edge 44 of the dished suction plate 26 is clamped to the underside of the suction box 12 using this formed rubber 42. Bolts 46 or other attaching means are used therefor. In addition a circumferential lip 48 which has a rectangular profile is bonded to the formed rubber 42. This lip 48 consists by way of example of a closed-cell foam material and is flexible such that it can be compressed to the plane 50 of the suction pad 30. When the suction box 12 is placed on the surface of one or more workpieces, the lip 48 is compressed until both the lip 48 as well as the suction pad 30 lie snugly on the workpiece. A tight lateral closure is thereby created. Moreover, which is particularly the case with workpieces projecting laterally beyond the suction box 12, specifically with panels, a certain safety margin is provided against the workpiece peeling away from the suction unit 20 because the lip 48 lies snugly on the upper side of the workpiece, even if the workpiece bows when it is lifted.

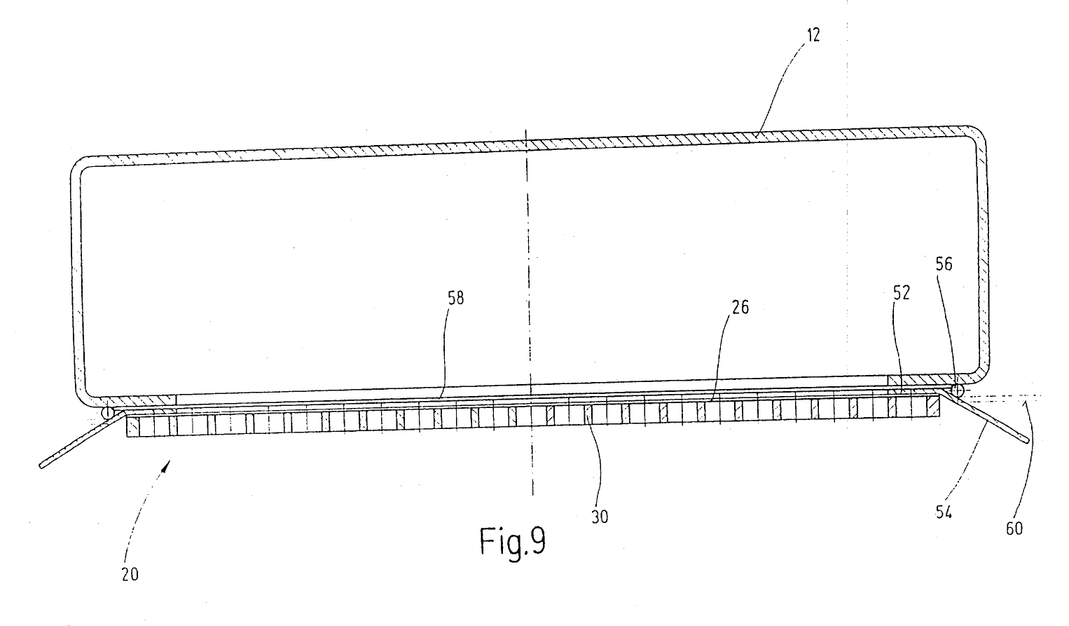

FIG. 9 shows a second aspect of the suction unit 20 which is constructed as follows. The suction plate 26 is bonded to the suction pad 30, whose shape is as shown in FIG. 6, in the form of a thin sheet. A rubber sheet 52 which has a laterally projecting edge lies against this suction plate 26. The rubber sheet 52 is specifically bonded to the upper side of the suction plate 26 only in the edge area. In order to turn the lip 54 downward, the underside of the suction box 12 has a welded-on circular profile 56, which turns the lip 54 downward. A perforated plate 58 lies against the rubber sheet 52, which serves to provide support and stability for the suction box 12. When the suction box 12 is positioned on a workpiece and the workpiece is pulled by vacuum, the suction pad 30 is compressed and the lip 54 is folded back, so that the latter occupies the position indicated by the broken line. The suction pad 30 is compressed to the plane 60. The rubber sheet 52 can also be configured such that it assumes the function of the suction plate 26, so that the suction plate can be eliminated.

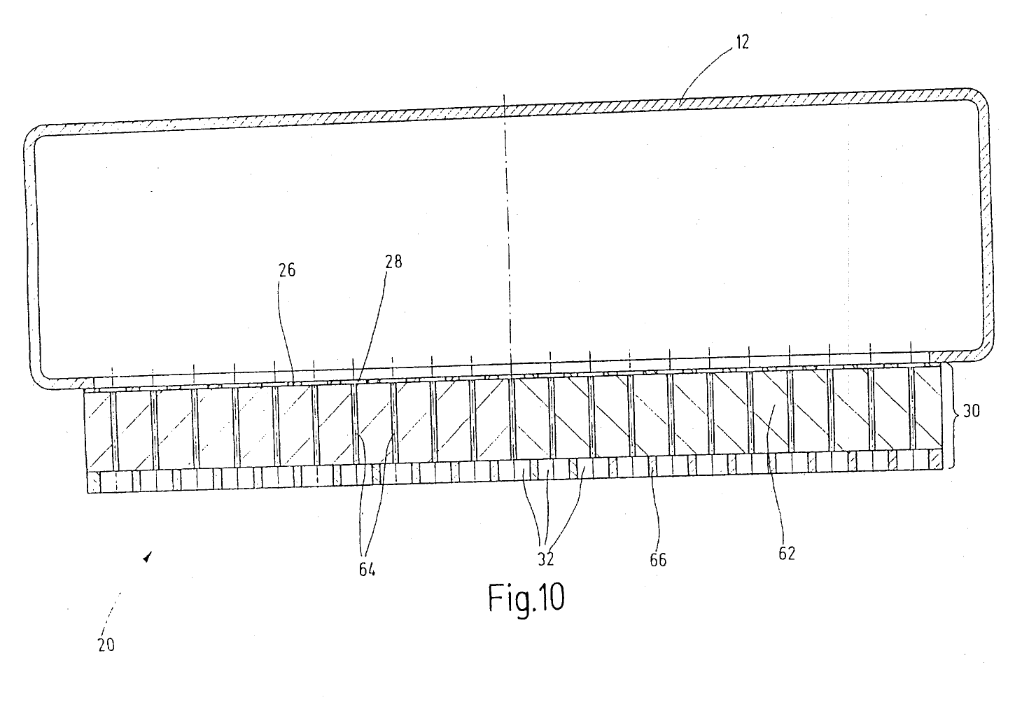

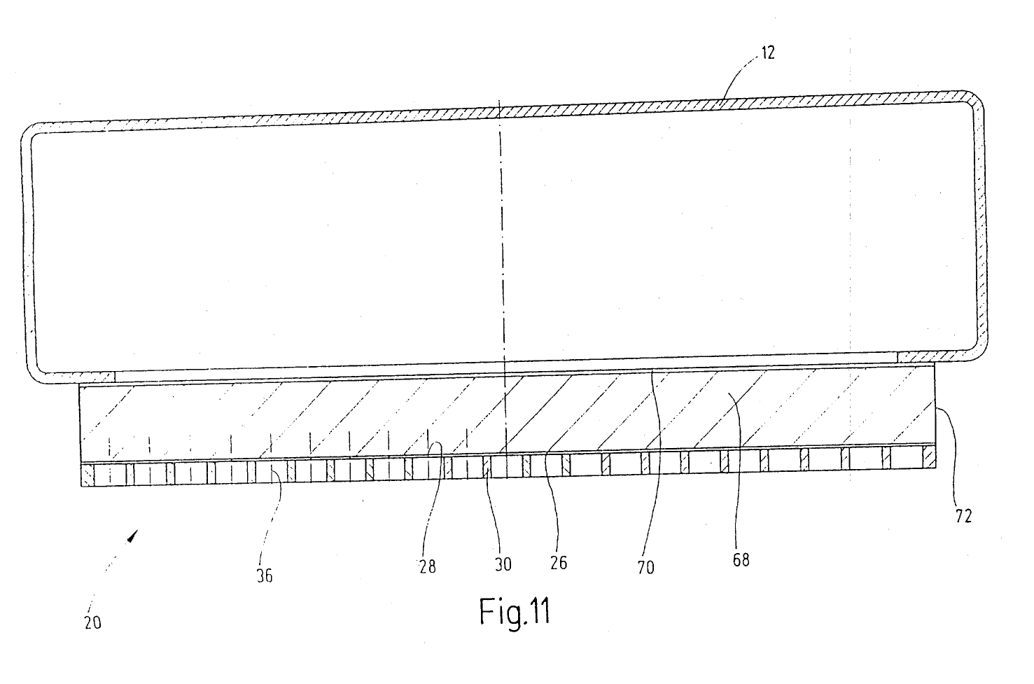

FIG. 10 shown a further aspect of the suction unit 20, in which the suction plate 26 has relatively large openings 28. Attached to this suction plate is a two-piece suction pad 30, whose first piece consists of an air-impermeable pad 62 which has ducts 64 aligned with the openings 28. These ducts 64 have a relatively small flow cross section and thereby create the desired resistance to air flow. Attached to the pad 62 is a second pad 66 of closed-cell rubber which has suctions chambers 32. The structure of this suction unit 20 is also relatively flexible, so that objects with a slightly uneven surface can be lifted by vacuum without difficulty.

FIG. 11 shows a fourth aspect of the suction unit 20, in which an air-permeable pad 68 is attached to the underside of the suction box 12. This pad is supported by way of example against a perforated plate 70. A suction plate 26 configured as a film is bonded to the underside of the pad 68, said plate in turn carrying the suction pad 30. The openings 28 in the suction plate 26 align with the suction openings 36 in the suction pad 30. To prevent air from being drawn in around the circumferential surface of the pad 68, it is sealed in an air-tight manner along its circumferential surface 72. The suction plate 26 can be made either of metal, for example, a stainless steel or aluminum foil, or it can also be made of plastic. The construction of this suction unit 20 is also relatively flexible, so that objects with slightly uneven surfaces can be picked up by vacuum without difficulty.

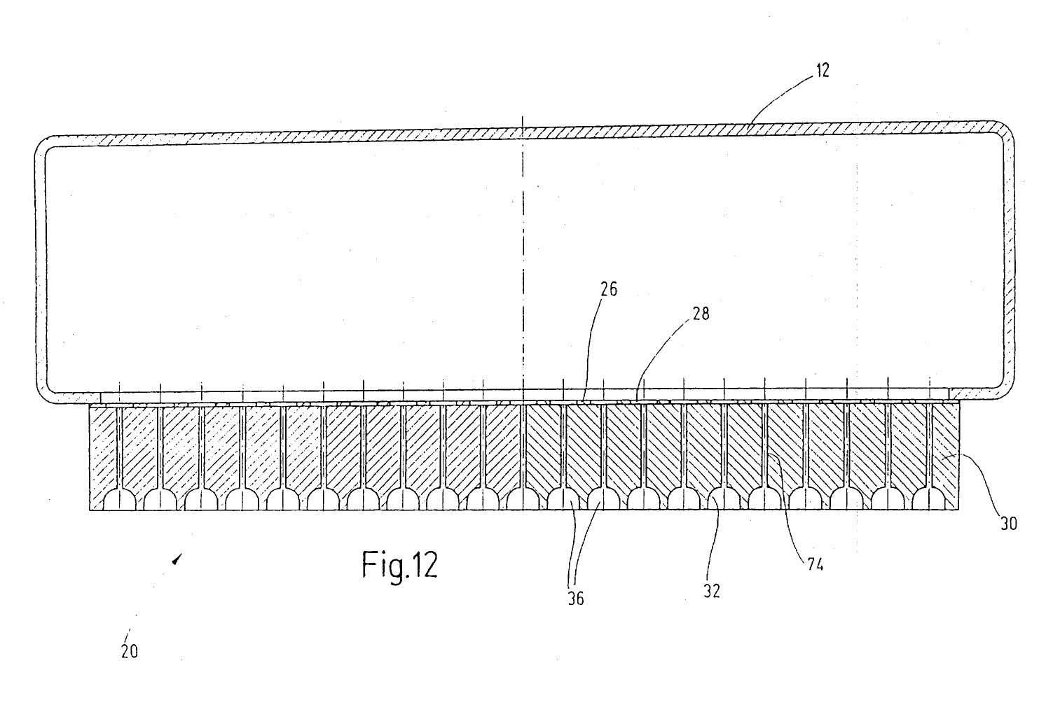

FIG. 12 shows a fifth aspect of the suction unit 20, in which the suction plate 26 has relatively large openings 20 and carries a suction pad 30, which is provided with suction openings 36. These suction openings 36 have a cross section which becomes larger toward of the workpiece (not shown).

The suction openings 36 have a passage 74 which possesses a relatively small flow cross section. This passage 74 expands in a tulip shape into the suction chamber 32, which then lies on the upper side of the workpiece. This suction unit 20 is also relatively flexible, whereby it can compensate for irregularities.

In a version of the invention not shown, the suction pad 30 extends laterally beyond the suction plate 26. This creates a projecting edge. However, this edge does not have any suction chambers. To obtain increased flexibility for the edge, the suction pad 30 is scored where it turns into the edge. In addition, the edge is backed by foam rubber, and this foam rubber provides support toward the suction chamber, for example, so that the edge projects in the direction of the workpiece to be lifted by vacuum. The overall spring constant of the edge consequently results from the spring constant of the actual edge, that is, from its compressibility and from the spring constant, or the compressibility, of the foam rubber backing. The edge can be moved slightly and is still simple in construction.

All flexible suction units have the additional advantage that laterally projecting sheet metal panels can be lifted easily, since the bowing of the panel is compensated for by the flexibility of the suction unit 20, without the panel peeling away from the suction pad 30. Mention must be made that the suction plate 26 does not absolutely have to be made of metal, it can also be made of plastic.

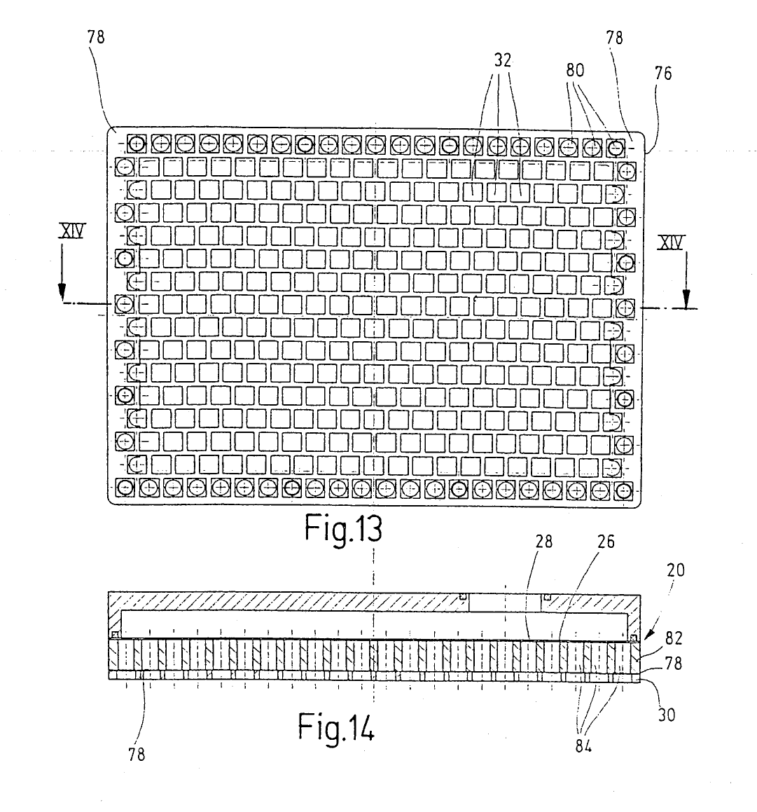

FIG. 13 shows a top view of the suction pad 30, where a sandwich plate 78 is bonded to the suction pad 30 in the area of the edge 76. This sandwich plate 78 is furnished with openings 80 corresponding to the suction openings 32 and functions as a support for the edge area of the suction pad 30, so that the latter does not collapse. FIG. 14 shows the section XIV-XIV which depicts the sandwich-type construction of the suction unit. An intermediate pad 82 and the sandwich plate 78 are located between the suction plate 26 and the suction pad 30. The suction openings 32, the openings 80, intermediate openings 84 in the intermediate pad 82 and the opening in the suction plate 26 are aligned.

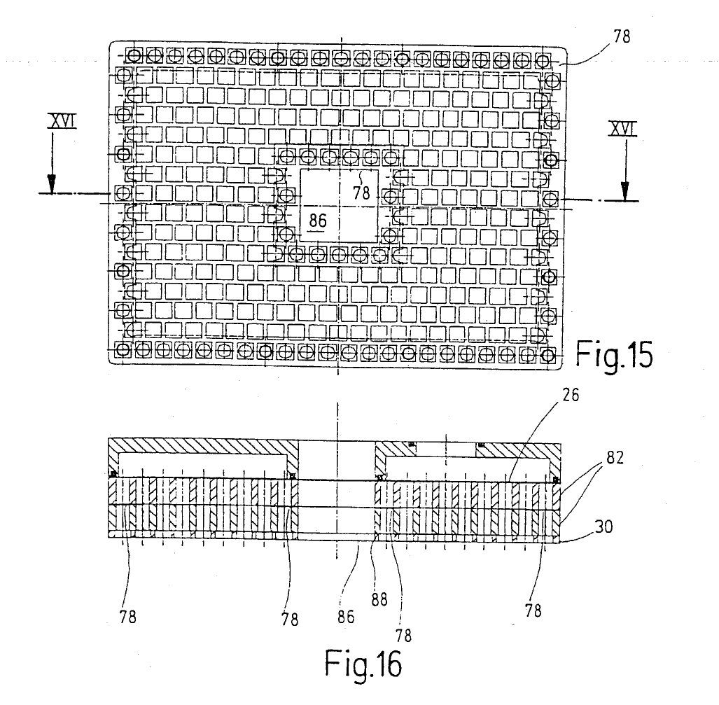

In the aspect of the invention shown in FIGS. 15 and 16, the suction pad 30 has an aperture 86 which is intended for a detection system. Through this aperture a camera, for example, can identify the object to be lifted by vacuum, or the camera can be located in the aperture. Here too, the edge area 88 is supported by a strip-shaped sandwich plate 78 and protected against collapse. As can be seen from the drawing, the intermediate pad 82 can consist of several layers.

What is claimed is:

1. Handling device, specifically vacuum handling device having a suction chamber (12) forming a vacuum reservoir, at least one vacuum blower (22), specifically a handling device (16) and a suction unit (20) closing off the suction chamber (20) toward one or several workpieces to be lifted by vacuum, where the suction unit (20) has a suction plate (26) with flow changing means and the suction plate (26) is covered by a flexible suction pad (30) toward the workpiece or workpieces and the suction pad (30) is furnished with suction openings (36) which correspond to the flow changing means, where the suction pad (30) consists of an especially flexible, dense material and the means to change air flow of the suction plate (26) and/or the suction openings of the suction pad (30) have a resistance to flow, characterized in that at least one intermediate pad is interposed between the suction pad (30) and the suction plate (26), also consisting of a flexible material and furnished with through openings which correspond to the suction openings (36).

2. Handling device, specifically vacuum handling device from claim 1, wherein the suction unit (20) has an additional flexible lip (48, 54) around its circumference.

3. Handling device, specifically vacuum handling device from claim 2, wherein the edge (48, 54) is a foam or a rubber lip which projects beyond the free plane (50) of the suction unit (20).

4. Handling device, specifically vacuum handling device from claim 2 or 3, wherein the edge (48, 54) is attached by means of clamping or bonding.

5. Handling device, specifically vacuum handling device from one of the preceding claims, wherein the suction unit (20) is bonded to the suction box (12) or is solidly clamped thereto.

6. Handling device, specifically vacuum handling device from one of the preceding claims, wherein the suction plate (26) has a dished configuration and has a circumferential edge (44) by means of which the suction plate (26) is solidly clamped to the suction box (12).

7. Handling device, specifically vacuum handling device from one of the preceding claims, wherein the suction pad (30) is configured as a film.

8. Handling device, specifically vacuum handling device from one of the preceding claims, wherein the suction plate (26) is supported on its back side by means of a flexible pad (68) permeable to air.

9. Handling device, specifically vacuum handling device from one of the preceding claims, wherein the suction pad (30) is configured in several pieces, and one piece is formed by an air-impermeable, flexible pad (62) which has air passages (64).

10. Handling device, specifically vacuum handling device claim 9, wherein the pad (62, 68) has lateral surfaces which are sealed tight against air.

11. Handling device, specifically vacuum handling device from one of the preceding claims, wherein the suction pad (30) has suction openings (36) whose cross sections expand in the direction of the workpiece or workpieces.

12. Handling device, specifically vacuum handling device from claim 11, wherein the suction cross sections expand in the shape of a tulip.

13. Handling device, specifically vacuum handling device from one of the preceding claims, wherein the flexible, dense material is a closed-cell foam.

14. Handling device, specifically vacuum handling device from one of the preceding claims, wherein the suction pad (30) has a circumferential edge projecting beyond the suction plate (26).

15. Handling device, specifically vacuum handling device from one of the preceding claims, wherein the suction plate (26) has a circumferential edge projecting beyond the suction pad (30).

16. Handling device, specifically vacuum handling device from one of the preceding claims, wherein the flow changing means of the suction plate (26) or the suction openings (36) of the suction pad (30) respectively have a regular grid pattern, for example a honeycomb pattern.

17. Handling device, specifically vacuum handling device from one of the preceding claims, wherein the flow changing means of the suction plate (26) or the suction openings (36) of the suction pad (30) respectively have a grid pattern matching the arrangement of the workpieces.

18. Handling device, specifically vacuum handling device from one of the preceding claims, wherein a sandwich plate (78) is located between the intermediate pad (82) and the suction pad (30).

19. Handling device, specifically vacuum handling device from claim 18, wherein the sandwich plate (78) extends over only a part of the cross sectional area of the intermediate pad (82).

20. Handling device, specifically vacuum handling device from claim 19, wherein the sandwich plate (78) is configured in the form of strips and is disposed in the edge area of the intermediate pad (82) or of apertures (86).

21. Handling device, specifically vacuum handling device from claim 19 and 20, wherein the sandwich plate (78) is configured in the form of strips and the strips are disposed at a distance from each other.

22. Handling device, specifically vacuum handling device from one of the claims 1 to 18, wherein the sandwich plate (78) extends over the entire cross sectional area of the intermediate pad (82).

23. Handling device, specifically vacuum handling device from one of the preceding claims, wherein several intermediate pads (82) and/or sandwich plates (78) are furnished and the suction unit (20) is of sandwich construction.

24. Handling device, specifically vacuum handling device from one of the preceding claims, wherein the flow changing means are a plurality of openings (28), flow resistances and/or flow valves.

25. Handling device, specifically vacuum handling device from claim 25, wherein the flow valves can be actuated individually or in groups.
